(19) United States
(12) Patent Application Publication
(10) Pub. No.: US 2006/0251500 A1
(43) Pub. Date: Nov. 9, 2006

(54) Automatic apparatus for laying floor of tiles

(76) Inventor: Luciano Di Giacomo, Chieti Scalo (CH)

Correspondence Address: YOUNG & THOMPSON, 745 SOUTH 23RD STREET, 2ND FLOOR, ARLINGTON, VA, 22202, US

(21) Appl. No.: 10/547,414

(22) PCT Filed: Feb. 19, 2004
(86) PCT No.: PCT/IT04/00070

§ 371 Date: Jun. 30, 2006

(30) Foreign Application Priority Data
Feb. 19, 2003 (IT) CH2003A000002

(51) Int. Cl. B60P 3/00

(52) U.S. Cl. 414/459

(57) ABSTRACT

A device for lying floors of any kind such as tiles, majolica, brickwork, concrete tiles etc., very skillfully without the need for a skilled tile layer and with a great efficiency in terms of paved area per time unit. The device is automated and includes a bridge crane provided with elements for gripping, aligning, and shifting one or more tiles at the same time and being able to move along a plane parallel to the floor on a couple of rails or guides generally coplanar with each other and disposed along two directions perpendicular to each other.

The present invention relates to building industry and particularly laying of floors even and above all with large extension.

As known, laying of tiles and generally floors requires specialized labour and a very long working time causing the cost to increase. It is then desirable to find a system able to allow floors to be laid in short time without the need for skilled workers.

The main object of the present invention is to overcome the above-mentioned problems by providing an apparatus able to lay floors of any kind such as tiles, majolica, brickwork, concrete tiles etc., very skilfully without the need for a skilled tile layer and with a great efficiency in terms of paved area per time unit.

This has been accomplished according to the invention by providing an automated device having a bridge crane provided with means for gripping, aligning and shifting one or more tiles at the same time and being able to shift along a plane parallel to the floor on a couple of rails or guides generally coplanar with each other and disposed along two directions perpendicular to each other.

A better understanding of the invention will follow from the following detailed description with reference to the accompanying drawings that show by way of a not limited example a preferred embodiments thereof. In the drawings:

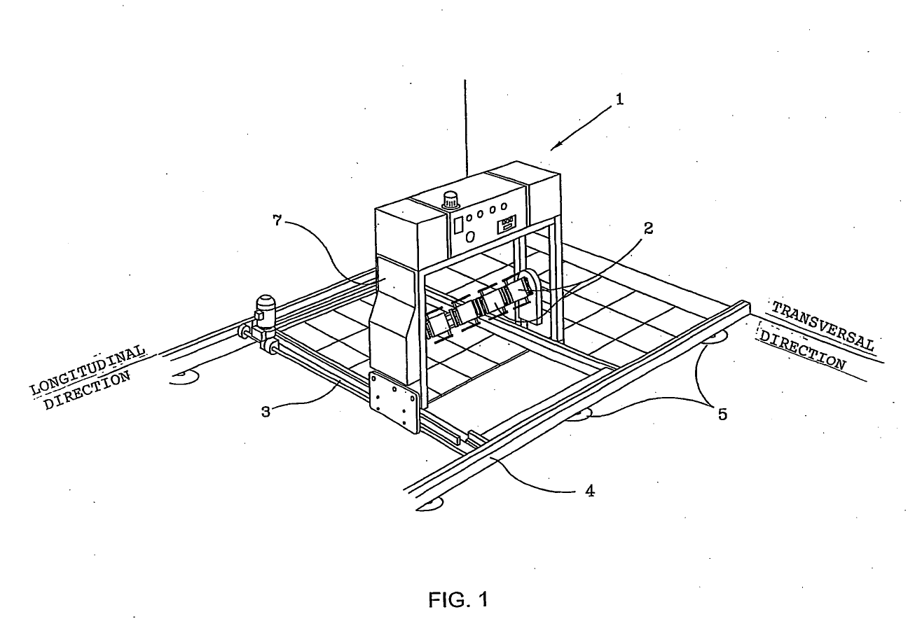

FIG. 1 is a three-dimensional view showing how the device according to the invention is moved upon lying tiles;

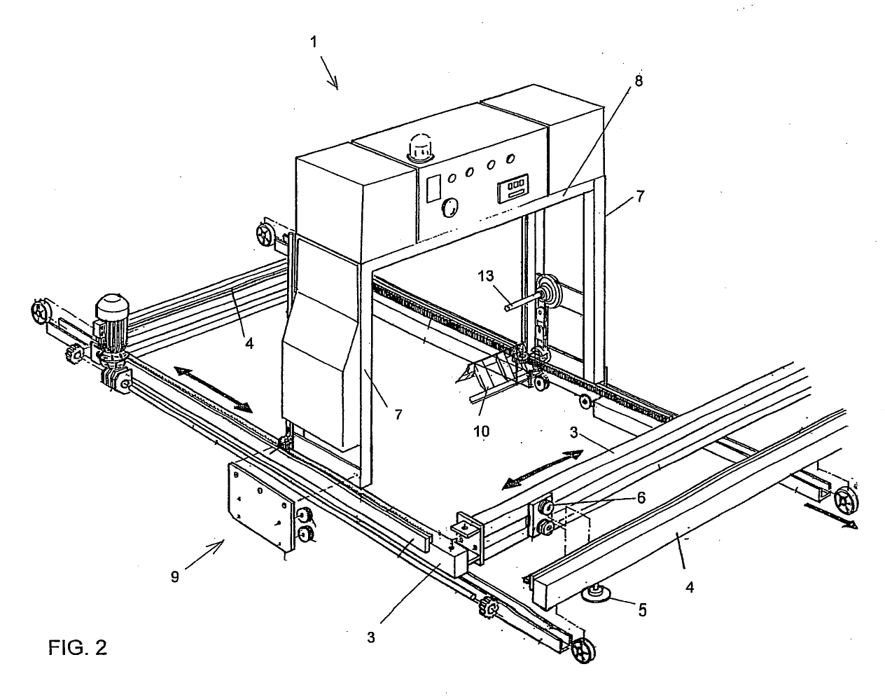

FIG. 2 is a three-dimensional view showing the main portions of the tile lying device;

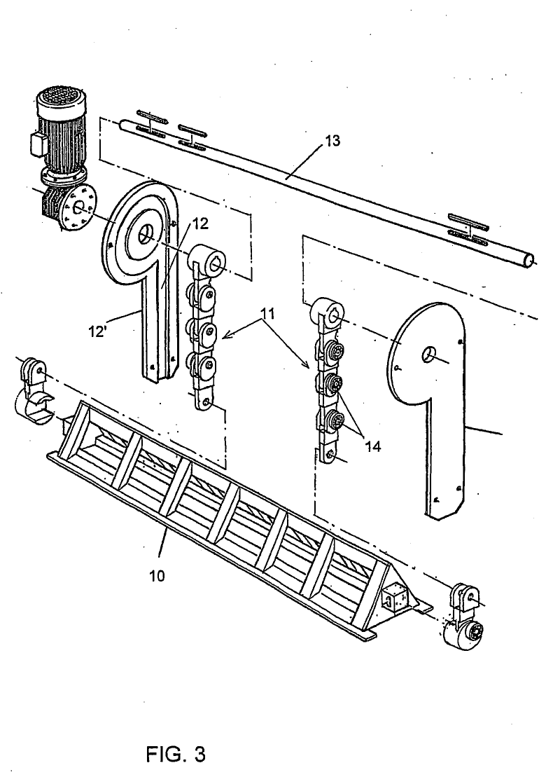

FIG. 3 is an exploded view showing the main portions of the system for shifting the tile carrying gripper;

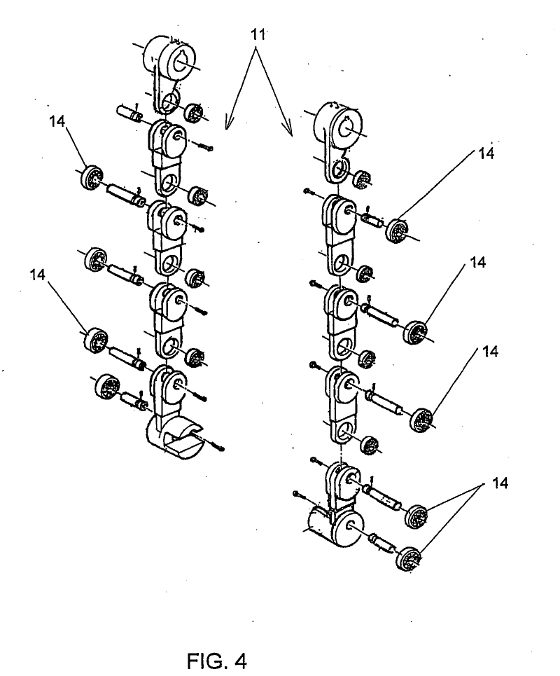

FIG. 4 is an exploded view of the end chains of the tile carrying gripper shifting system;

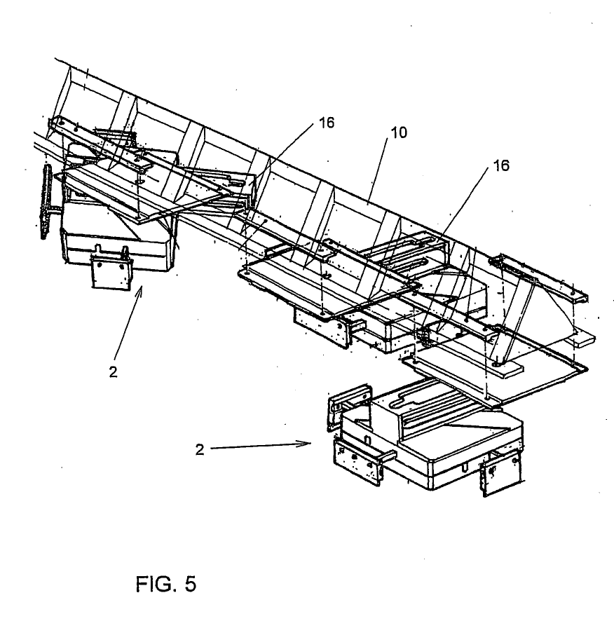

FIG. 5 is a three-dimensional view showing the possible positioning of the gripper to lay tiles straightforwardly or diagonally;

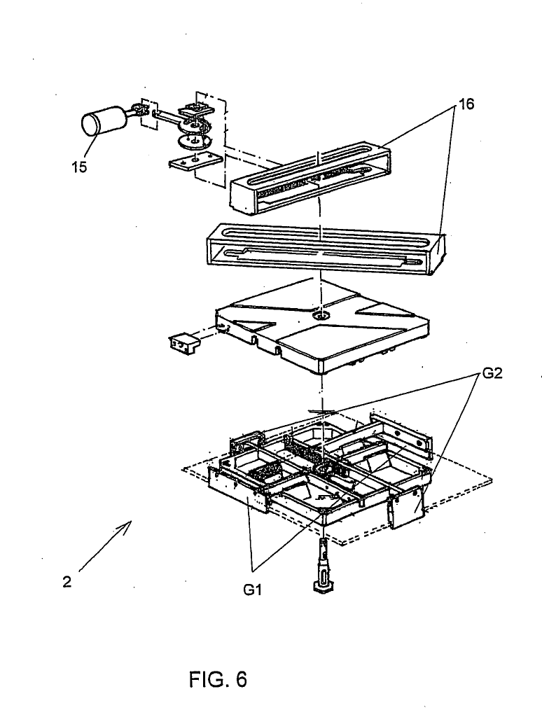

FIG. 6 is an exploded view of a tile carrying gripper;

With reference to the figures, the device according to the invention includes essentially a bridge crane 1, means 2 for gripping, shifting, lying tiles, a first track or couple of parallel rails or guides 3 on which such bridge crane 1 is moved upon lying rows of tiles after one another, and a second track or couple of parallel rails or guides 4 perpendicular to the first ones on which the first track and the bridge crane integral with it is moved.

In the embodiment disclosed to which reference is made below the device is provided with gripping-shifting-positioning means 2 including four tile carrying grippers. Of course, according to the invention, devices with one, two, three, four, five or more grippers can be provided keeping the inventive step and the technical teachings at the base of the present invention unchanged.

In other words, bridge crane 1 handling the tiles to be laid is moved along a first track 3 consisting of a rectangular frame which in turn is moved along a second track 4 to a direction perpendicular to the direction of movement of bridge crane 1.

According to the invention, the two tracks 3 and 4 on which bridge crane 1 is moved form a plane parallel to the tile laying plane: if the direction of movement of bridge crane 1 on first track or frame 3 is referred to as “transversal”, and the direction of movement of the latter with respect to second track 4 is referred to as “longitudinal”, once the device lays four transversal rows of tiles (because four tile carrying grippers are provided in the example shown) between the guides of second track 4, bridge crane 1 is then moved in the longitudinal direction on second track 4 until the next length of bed to be paved adjacent to the just paved bed length is reached, and is also moved transversally on first track or frame 3 to reach the starting tile laying position again. To save time, the longitudinal, transversal movement of positioning bridge crane 1 again are preferably simultaneous.

The three main portions which the invention consists of will be explained into detail hereinafter, and namely: bridge crane 1 with tile handling means 2, first track or transversal frame 3, and second longitudinal track 4 which is secured temporarily or laid down on the bed on which the pavement has to be laid. Bridge crane 1, transversal frame 3, and second track 4 are preferably of metal.

The bridge crane, also referred to hereinafter as laying crane because of its function of lying tiles, consists essentially of a vertical frame shaped like a reversed “U” with two vertical side uprights or shoulders 7 and an upper horizontal cross beam 8. The base of each upright 7 is secured to a respective sliding carriage 9 able to move on the corresponding transversal track or guide 3.

The tile gripping-shifting-positioning means 2 includes a horizontal shaft 13 rotating about its longitudinal axis which is able to drive a horizontal framework 10 by two special end chains 11. Framework 10 disposed between the two side uprights 7 of bridge crane 1 under upper cross beam 8 thereof supports one or more grippers or vices 2 able to grip the tiles to be laid.

According to a peculiar feature of the invention, the links of such special end chains 11 are able to slide inside guide grooves 12 forming a suitable path for chains 11 and the gripper carrying framework 10 as well.

In particular, the motion of the framework and the grippers connected thereto is a roto-translation: when grippers 2 are in the loading position, i.e. at the upper end of stroke at such a height from the ground that the installer should not stoop, each tile is put on the respective gripper with its rear side directed upwards, and once the grippers are tightened and a suitable amount of adhesive is coated onto the tiles, the grippers are rotated and lowered to the lying bed until their rear sides face horizontally the latter. Now the motion of the grippers is a only vertical traverse downwards so that enough pressure is applied to the tiles to spread evenly the adhesive between each tile and the lying bed.

Once reached the predetermined lower end of stroke, the grippers release the tiles and move to the opposite direction. After a short vertical traverse, the grippers starts also to rotate to reach the tile loading position again that corresponds to a rotation by about 130° with respect to the lying bed in the embodiment shown.

With particular reference to FIGS. 3 and 4, two parallel arms perpendicular to the axis of a rotating shaft (13) are journalled by the latter and carry the two upper end links of chains 11 hinged thereto. This means that chains 11 do not wind directly round the drive shaft but follow a predetermined path at a distance from the rotation axis of shaft 13, which path is formed by a respective guide. In the embodiment disclosed, each link of chains 11 is preferably provided with at least a sliding bearing 14 (or other sliding member) which moves inside the corresponding guide grooves 12 during the whole motion of the chain. More specifically, groove 12 forms a path for the links, the shape of which is preferably a circumference from which a segment tangential thereto branches off. The paths formed by guides 12 for the two end chains 11 are specular to each other. Of course, the length of chains 11 is such that the lower end links integral with gripper carrying framework 10 have covered a length of the circumference at the upper end of stroke, and have reached the lower end of the rectilinear vertical length of the respective guide grooves at the lower end of stroke. In this connection, it should be appreciated that in the illustrated embodiment the lower end links of chains 11 are provided with two sliding bearings 14 that slide in respective guides 12 to cause framework 10 to rotate at the upper position of its roto-translation motion, thus causing the end links (and then the framework integral therewith) to follow the curvature of the guides.

Before lying the next row of tiles, the device traverses automatically by one predetermined step which has the same length as the selected tiles plus the “gap” between adjacent tiles. Such traverse is carried out with respect to first track 3.

After all of the rows of tiles corresponding to the length of first track or frame 3 are laid, the latter is shifted sideways together with lying crane 1 to the longitudinal direction on second track 4 until the position of lying the next rows of tiles is reached. To this end, lying crane 1 is aligned with the first row laid, and the lying steps are repeated in a similar way as the previous ones. In order to reduce the dead times, the re-alignment motion of lying crane with respect to the first-laid row, i.e. its back shift with respect to first track or frame 3 up to the starting position, is preferably performed simultaneously with the shift or side traverse of such frame 3 with respect to second longitudinal track 4.

Before disclosing in detail the tile grip/release means such as grippers 2 and gripper drive means for the motion from the upper loading position to the lower lying position and vice versa, it should be noted that lying crane 1 is moved on frame 3 preferably by a rack-and-pinion means installed between at least one carriage 9 at the base of side uprights 7 and the corresponding guide section which is part of the first track or frame 3.

More specifically, the pinion is integral with the carriage and meshes with a rack secured to track 3 on which carriage 9 rolls. Such pinion is rotated by a suitable motor of the known type.

As far as the motion of the whole frame/lying crane assembly is concerned, shift means of the rack-and-pinion type are also provided here, such rack being secured inside at least one of the two rails of second longitudinal track 4, and the pinion meshed therewith and moved by a further motor anchored to frame 3 is disposed at one end of frame 3 that slides on such longitudinal track 4.

It is preferable that both carriages 9 of laying crane 1 are provided with rack-and-pinion shift means and both ends of transversal frame 3 are provided with corresponding rack-and-pinion shift means in order to ensure a greater precision of the motion of the lying crane with respect to the floor to be laid and then an essentially perfect lying of tiles. The perfect synchronism of the movements is guaranteed by the presence of a shaft disposed along one side of frame 3 that joins and moves the two pinions on second track 4.

As far as the drive means of the tile carrying grippers that controls the opening/closure of the latter engaging the tiles to be laid is concerned, the embodiment disclosed provides two perpendicular couples G1 and G2 of jaws opposite to each other and able to tighten the tiles to all their four sides by a mechanical drive system controlled by an oleodynamic actuator 15.

More specifically, each jaw is integral with a respective rack, and the four racks mesh with one central pinion that causes the jaws to close/open in a perfectly synchronized way.

The rotation of the central pinion is controlled by an oleodynamic actuator 15 that blocks the jaws at the end of stroke either in the closing (tile tightening) position or opening (tile releasing) position. To this end the device disclosed herein provides a hydraulic system of the known type provided with a suitable pump and tank (not shown).

It is provided according to the invention that the amplitude of the shift stroke of the jaw couples G1 and G2 is limited to guarantee the maximum precision of opening/closing of the grippers for different sizes of the tiles so that it is necessary to adjust the position of the end of stroke of the jaws according to the effective size of the tiles. As the two couples G1 and G2 of jaws meshes with one central pinion, such adjustment of the end of stroke is self-centring because the shift of a jaw causes the opposite jaw to be shifted by the same extent due to the presence of only one pinion.

Advantageously, it is possible to adjust in a different way the end of stroke of a couple of jaws with respect to the other by changing the length of the corresponding racks (for example by adding suitable extensions) in order to lay also rectangular tiles without requiring any modification of the device.

At last, grippers 2 can be rotated about their lying plane to allow tiles to be laid diagonally. In this case, the grippers are also shifted in pairs by separating them from each other and keeping the side distance unchanged to position correctly the tiles. To this end each gripper 2 is secured to framework 10 by a slide guide 16 that can be disposed transversally or at an angle to the axis of the framework.

Such framework 10 has preferably a triangular cross section and includes three longitudinal members disposed like a triangle and stiffened by a plurality of transversal ribs placed all over the length of the framework. Tile carrying grippers 2 are located to one of the three side faces of framework 10, i.e. the face that is parallel to the lying bed at the lower end of stroke.

Guide grooves 12 of chain 11 are preferably formed in suitable rigid side plates 12′ connected to side uprights 7 of lying crane 1.

According to the present invention, the sections of the rails of second track 4 are provided with vibration-damping shoes 5 which can be adjusted in height to allow for the track to be levelled. The levelling is preferably carried out by a high-precision laser pointer of the known type.

It should be noted that floors can also be laid on uneven lying beds by using a suitable amount of adhesive because the device disclosed so far is able to lay tiles onto a predetermined plane apart from that the latter is parallel to the underlying bed, provided that enough adhesive spread under the tiles fills the space between them and the lying bed.

Advantageously, the device according to the present invention can lay tiles with a particularly high hour yield reaching a daily laying rate of about 300 m².

A further advantage of the invention is that a standing worker shall only position the tiles onto the grippers and spread thereon enough adhesive to fill the space between the lying bed and the tiles just entering height and gap parameters by keyboard and display.

Still another advantage of the invention consists in that less tiles are broken with respect to the manual lying because of the even light hammer blows given by the worker to each tile to settle the adhesive. Even if such blows are not strong, however, they are circumscribed to small areas of the tiles which are brittle in itself. In contrast, the device disclosed so far lays the tiles by applying a constant and uniform pressure all over the surface of the tiles.

In the embodiment described, motions, actuators, and motors are controlled by one or more personal computers of the known type which are commonly used by those ordinary skilled in the art.

It is self-evident that, as an alternative to the hydraulic actuators, also pneumatic systems or mechanical and/or electrical means can be used with the same operation known to those skilled in the art. In a simplified variation of the invention, the motion of first track or frame 3 on second longitudinal track 4 is not controlled by motor but manually by the worker.

1. An automated device for lying floors of tiles, briquettes, majolica or the like, wherein it comprises a bridge crane (1) provided with means for gripping, aligning, shifting and lying one or more tiles at the same time and being able to move along a plane parallel to the floor on a couple of rails or guides (3,4) generally coplanar with each other and disposed along two directions perpendicular to each other.

2. The device according to claim 1, characterized in that said couple of rails includes a first track or couple of parallel guides (3) on which said bridge crane (1) is moved upon lying rows of tiles after one another, and a second track or couple of parallel guides (4) perpendicular to the first ones on which first track (3) and bridge crane (1) integral with it is moved manually or automatically.

3. The device according to claim 1, characterized in that bridge crane (1) handling the tiles to be laid is moved along a first track (3) consisting of a rectangular frame which in turn is moved along a second track (4) to a direction perpendicular to the direction of movement of bridge crane (1).

4. The device according to claim 1, characterized in that the two tracks (3 and 4) on which bridge crane (1) is moved form a plane parallel to the tile laying plane on which bridge crane (1) is moved to a “transversal” direction on first track or frame (3) which in turn is moved to a “longitudinal” direction on second track (4), the transversal, longitudinal movements being independent of each other.

5. The device according to claim 1, characterized in that bridge crane or laying crane (1) consists essentially of a vertical frame shaped like a reversed “U” with two vertical side uprights or shoulders (7) and an upper horizontal cross beam (8), the base of each upright (7) being secured to a respective sliding carriage (9) able to move on the corresponding track or guide of the first track or frame (3).

6. The device according to claim 5, characterized in that said tile gripping-shifting-positioning means includes a horizontal shaft (13) rotating about its longitudinal axis and able to drive a horizontal framework (10) by two special end chains (11), said framework 10 supporting one or more grippers or vices (2) able to grip the tiles to be laid.

7. The device according to claim 5, characterized in that said framework (10) is disposed between the two side uprights (7) of lying crane (1) under upper cross beam (8) thereof.

8. The device according to claim 6, characterized in that the links of said special end chains (11) are able to slide inside suitable guide grooves (12) forming a suitable path for chains (11) and framework (10) carrying grippers (2) as well.

9. The device according to claim 8, characterized in that the motion of framework (10) and grippers (2) connected thereto is a roto-translation so that when grippers (2) are in the tile loading position at the upper end of stroke where each tile is put on the respective gripper with its rear side directed upwards, and once the grippers are tightened and a suitable amount of adhesive is coated onto the tiles, the grippers are rotated and lowered to the lying bed until their rear sides face horizontally the latter, the motion of grippers (2) being now only a vertical traverse downwards so that enough pressure is applied to the tiles to spread evenly the adhesive between each tile and the lying bed.

10. The device according to claim 9, characterized in that once reached the lower end of stroke, grippers (2) release the tiles and move to the opposite direction so that after a short vertical traverse, the grippers starts also to rotate to reach the tile loading position again.

11. The device according to claim 10, characterized in that the tile loading position of grippers (2) corresponds to a rotation by about 130 with respect to the lying bed.

12. The device according to claim 6, characterized in that two parallel arms perpendicular to the axis of a rotating shaft (13) are journalled by the latter and carry the two upper end links of chains (11) hinged thereto, thus providing that chains (11) do not wind directly round drive shaft (13) but follow a predetermined path at a distance from the rotation axis of shaft (13), which path of the chains is formed by a respective guide.

13. The device according to claim 12, characterized in that each link of chains (11) is provided with at least a sliding bearing (14) or other sliding member which moves inside the corresponding guide grooves (12) during the whole motion of the chain.

14. The device according to claim 13, characterized in that groove (12) forms a path for the links, the shape of which is preferably a circumference from which a segment tangential thereto branches off, the paths formed by guides (12) for the two end chains (11) being specular to each other.

15. The device according to claim 14, characterized in that the length of chains (11) is such that the lower end links integral with gripper carrying framework (10) have covered a length of the circumference of guide groove (12) at the upper end of stroke, and have reached the lower end of the rectilinear vertical length of the respective guide grooves at the lower end of stroke.

16. The device according to claim 15, characterized in that the lower end links of chains (11) are provided with two sliding bearings (14) that slide in respective guides (12) to cause framework (10) to rotate at the upper position of its rototranslation motion, thus causing the end links (and then the framework integral therewith) to follow the curvature of the guides.

17. The device according to claim 2, characterized in that after the tile handling means lays the tiles onto the lying bed, the device traverses automatically by one predetermined step which has the same length as the selected tiles plus the “gap” between adjacent tiles, said traverse being carried out with respect to first track 3 before the next row of tiles is laid.

18. The device according to claim 17, characterized in that after all of the rows of tiles corresponding to the length of first track or frame (3) are laid, the latter is shifted sideways together with bridge crane or lying crane (1) to the longitudinal direction on second track (4) until the position of lying the next rows of tiles is reached so that lying crane (1) is aligned with the first row laid, and the lying steps are repeated in a similar way as the previous ones.

19. The device according to claim 5, characterized in that lying crane (1) is moved on frame (3) by a rack-and-pinion means installed between at least one carriage (9) at the base of side uprights (7) and the corresponding guide section which is part of the first track or frame (3).

20. The device according to claim 19, characterized in that the pinion is integral with carriage (9) and meshes with a rack secured to track (3) on which carriage (9) rolls, said pinion being rotated by a suitable motor of the known type.

21. The device according to claim 5, characterized in that the motion of the whole frame (3) /lying crane (1) assembly is controlled by shift means of the rack-and-pinion type, said rack being secured inside at least one of the two rails of second longitudinal track (4), and the pinion meshed therewith and moved by a further motor anchored to frame (3) being disposed at one end of frame (3) that slides on said longitudinal track (4).

22. The device according to claim 21, characterized in that both carriages (9) of laying crane (1) are provided with rack-and-pinion shift means and both ends of transversal frame (3) are provided with corresponding rack-and-pinion shift means in order to ensure a greater precision of the motion of the lying crane with respect to the floor to be laid and then an essentially perfect lying of tiles, the perfect synchronism of the movements being guaranteed by the presence of a shaft disposed along one side of frame (3) that joins and moves the two pinions on second track (4).

23. The device according to claim 21, characterized in that the drive means of the tile carrying grippers that controls the opening/closure of the latter engaging the tiles to be laid provides two perpendicular couples (G1 and G2) of jaws opposite to each other and able to tighten the tiles to all their four sides by a mechanical drive system controlled by an oleodynamic actuator (15).

24. The device according to claim 23, characterized in that each jaw is integral with a respective rack, and the four racks mesh with one central pinion that causes the jaws to close/open in a perfectly synchronized way.

25. The device according to claim 24, characterized in that the rotation of the central pinion is controlled by an oleodynamic actuator that blocks the jaws at the end of stroke either in the closing (tile tightening) position or opening (tile releasing) position, a hydraulic system of the known type provided with a suitable pump and tank (not shown) being connected thereto.

26. The device according to claim 23, characterized in that the amplitude of the shift stroke of the jaw couples (G1 and G2) is limited to guarantee the maximum precision of opening/closing of the grippers for different sizes of the tiles so that it is necessary to adjust the position of the end of stroke of the jaws according to the effective size of the tiles.

27. The device according to claim 1, characterized in that because of the meshing of the two couples (G1 and G2) of jaws with one central pinion, such adjustment of the end of stroke is self-centring because the shift of a jaw causes the opposite jaw to be shifted by the same extent due to the presence of only one pinion.

28. The device according to claim 1, characterized in that the length of the corresponding racks is changed (for example by adding suitable extensions) to adjust in a different way the end of stroke of a couple of jaws with respect to the other in order to lay also rectangular tiles without requiring any modification of the device.

29. The device according to claim 6, characterized in that grippers (2) are rotated about their lying plane to allow tiles to be laid diagonally, the grippers being also shifted in pairs by separating them from each other and keeping their side distance unchanged to position correctly the tiles.

30. The device according to claim 29, characterized in that each gripper (2) is secured to framework (10) by a slide guide (16) that can be disposed transversally or at an angle to the axis of the framework.

31. The device according to claim 6, characterized in that said framework (10) has a triangular cross section and includes three longitudinal members disposed like a triangle and stiffened by a plurality of transversal ribs placed all over the length of the framework, the tile carrying grippers (2) being located to the side face of framework (10) that is parallel to the lying bed at the lower end of stroke.

32. The device according to claim 8, characterized in that guide grooves (12) of chain (11) are formed in suitable rigid side plates (12′) connected to side uprights (7) of lying crane (1).
